(19) United States
(12) Patent Application Publication
(10) Pub. No.: US 2014/0027285 A1
(43) Pub. Date: Jan. 30, 2014

(54) PROCESS FOR PURIFYING ABSORBENTS COMPRISING POLYETHYLENE GLYCOL DIMETHYL ETHERS

(71) Applicant: Paul Parisi, Saint-Lambert (CA)

(72) Inventor: Paul Parisi, Saint-Lambert (CA)

(73) Assignee: ELECTROSEP TECHNOLOGIES INC., Saint-Lambert, QC (CA)

(21) Appl. No.: 14/111,297

(22) PCT Filed: Apr. 10, 2012
(86) PCT No.: PCT/CA2012/050228

§ 371 Date: Oct. 11, 2013

Related U.S. Application Data
(60) Provisional application No. 61/474,188, filed on Apr. 11, 2011.

(51) Int. Cl. B01J 20/34

(52) U.S. Cl. CPC B01J 20/3441
USPC 204/541

(57) ABSTRACT

A process for purifying polyethylene glycol dimethyl ethers (PGDE) based absorbent (known as Selexol®) having acidic contaminants and salts thereof, this process being particularly useful in an acid gas removal loop process (known as Selexol® process). A base, such as ammonium hydroxide (NH₃OH), is added to the absorbent to partly of fully convert the acid into simple salts. The salts are removed in an electrodialysis cell. The base can be added directly to the absorbent either from a fresh chemical feed or as base contained in the re-generator's generator's reflux stream. Alternatively the base can be added directly into the electrodialysis unit. The solution is diluted before electrodialysis. The absorbent can be simultaneously diluted and neutralized using reflux from the regeneration section that contains dissolved ammonia. The purified solution can be used again to remove carbon dioxide, hydrogen suphide, sulfur dioxide, mercaptans and other acid gases from a gas stream.

The invention relates to a process for depleting or removing acidic contaminants from polyethylene glycol dimethyl ethers (PGDE) based absorbent (known for instance as Selexol®).

A wide variety of absorption processes have been proposed for removing acid gases such as, for example, carbon dioxide, hydrogen sulphide, among others from process gas streams using absorbents comprising polyethylene glycol dimethyl ethers (PGDE). Acidic contaminants are generally heat stable and cannot be stripped off in a regeneration column. They can accumulate due to acid contaminants (other than hydrogen sulphide and carbon dioxide) removed from the gas stream or formed in situ. For removing carbon dioxide, hydrogen sulphide, sulfur dioxide, mercaptans and other acid gases from a gas stream, the gas stream is passed through a PGDE based absorbent, known for instance as Selexol®.

Such absorption processes typically involve passing the process gas stream containing one or more of the acid gases to an absorption zone wherein it is contacted with a lean solvent comprising the PGDE absorbent. A product gas stream, depleted in the acid gases relative to the process gas stream, is withdrawn from the absorption zone as a product. A rich solvent stream comprising the PGDE absorbent and the absorbed acid gases is also withdrawn from the absorption zone and passed to a regeneration zone, such as a stripping column, wherein the absorbed acid gases are desorbed from the solvent to provide a tail gas stream comprising the acid gases and the lean solvent stream herein before described.

A common problem in such acid gas absorption processes is that acids, such as formic, acetic and hydrochloric and/or associated salts such as sodium chloride, ammonium chloride, potassium chloride, sodium formate, ammonium formate, potassium formate etc. are often formed during one or both of the absorption and regeneration steps as a by-product or present in the gas feed gas stream to the absorption column. These and other salts could also be introduced into the solvent by liquid carryover from an upstream process or simply leaks of other fluids such as cooling water in the process and thus the solvent. These acids and salts do not have absorption capacity and cannot be regenerated under the conditions of the process. As PGDE is not an efficient buffer, a build up of the salts and acids may also result in serious corrosion issues.

Electrodialysis has been proposed as a method for removing heat stable salts from amine containing streams. In a typical electrodialysis process, such as the one disclosed in U.S. Pat. No. 5,910,611, caustic, e.g., sodium hydroxide, is added to the stream containing the heat stable amine salt in order to dissociate the heat stable anion from the heat stable salt and provide an amine in free base form and a simple heat stable salt, e.g., sodium sulphate. The simple salt is then separated by conventional electrodialysis wherein the charged ions permeate through anion- and cation-selective membranes. The amine, which is non-ionic, does not permeate through the membranes and is discharged from the electrodialysis zone as a product.

Conventional electrodialysis processes can operate in a batch mode wherein the process streams are recirculated until the desired amount of heat stable salts is removed. In U.S. Pat. No. 6,517,700, caustic is added directly into the electrodialysis stack (membrane assembly) and only the hydroxide anion passes into the amine stream.

However, the above mentioned processes are not adapted for the purification of a PGDE absorbent containing acidic contaminants and/or salt thereof.

According to an embodiment of the invention, it is provided a process for removing, at least in part, acidic contaminants from polyethylene glycol dimethyl ether, PGDE, based absorbent (known for instance as Selexol®). A base, such as ammonium hydroxide, is added to the absorbent to convert all or part of the acid into simple salts. The salts are removed in an electrodialysis cell. The purified solution can be used again to remove carbon dioxide, hydrogen sulphide, sulfur dioxide, mercaptans and other acid gases from a gas stream. The base can be added directly to the absorbent either from a fresh chemical feed or as base contained in the regenerator's reflux stream. Alternatively the base can be added directly into the electrodialysis unit. The solution can be diluted before passing into the electrodialysis cell.

According to an embodiment of the invention, it is provided a process for removing acidic contaminants or salts thereof, from an absorbent comprising polyethylene glycol dimethyl ether, PGDE. The process comprises the steps of:
contacting the absorbent with a base for partly or fully converting the contaminants into their corresponding salts containing anions and cations;
adding a fluid to the absorbent for diluting the PGDE;
introducing the absorbent into an electrodialysis cell;
electrodialyzing the absorbent for removing the salts from the absorbent; and
recovering the absorbent depleted of acidic contaminants.

In the process, the absorbent is contacted with the base either before being introduced into the electrodialysis cell or directly inside the electrodialysis cell.

An electrodialysis cell is used with at least one ion exchange membrane to selectively remove ionic species from the feed solution.

According to an embodiment of the invention, the acid contaminants and/or salts thereof in the PGDE absorbent are converted to simple salts by the addition of a base, such as KOH, NaOH, NH₃OH or the equivalent carbonates and bi-carbonates of the same bases. The feed solution of PGDE absorbent and base, is then passed through an electrodialysis cell with appropriate cationic and anionic ion exchange membranes to remove most of the cations and anions.

According to another embodiment of the invention, the base is added directly into the electrodialysis cell conjointly to the feed solution of PGDE absorbent.

The feed solution in both cases may be diluted before entering the modified electrodialysis zone. Dilution of the PGDE in the feed solution increases the mobility of the anions and cations and results in improved removal rates and higher current efficiency.

The process may provide a high degree of recovery of the absorbent depleted of acidic contaminants, and can be integrated within an acid gas-absorption process.

The process can be carried out in situ on an existing gas treating process using relatively small-scale equipment, which can be permanently installed, or temporarily in a semi-batch or continuous mode. The primary energy demand is the electromotive force to transport the minor components (contaminant salts) across the membranes plus electrical inefficiencies.

The invention thus also concerns a loop process for recovering acid gas from an acid gas stream, the loop process comprising the steps of:
i) passing an acid gas stream to an absorption zone wherein the acid gas stream is in contact with an absorbent of acid gases comprising polyethylene glycol dimethyl ethers PGDE;
ii) withdrawing from the absorption zone a product gas stream depleted of acid gases relatively to the gas stream;
iii) withdrawing from the absorption zone a rich solvent stream comprising the absorbent and absorbed contaminants having acids and salt thereof;
iv) passing the rich solvent stream to a regeneration zone wherein absorbed acid gases are desorbed from the rich solvent stream to provide a first tail gas stream comprising acid gases, and a lean solvent stream is formed, said lean solvent stream comprising PGDE absorbent and remaining contaminants having acids and/or salt thereof;
v) passing the lean solvent stream withdrawn from the regeneration zone to the absorption zone of step (i) for further treatment in a loop process;
vi) partially withdrawing via a bleed stream an amount of the lean solvent stream before the absorption zone;
vii) injecting a fluid to the bleed stream for diluting the PGDE;
viii) contacting the absorbent of the bleed stream with a base for partly or fully converting the contaminants into their corresponding salts containing anions and cations;
ix) introducing the absorbent into an electrodialysis cell;
x) electrodialyzing the absorbent for removing the salts from the absorbent; and
xi) recovering the absorbent depleted of acidic contaminants;
   the absorbent being contacted with the base before being introduced into the electrodialysis cell, or directly inside the electrodialysis cell.

The invention and its advantages will be better understood upon reading the following description made with reference to the accompanying drawings.

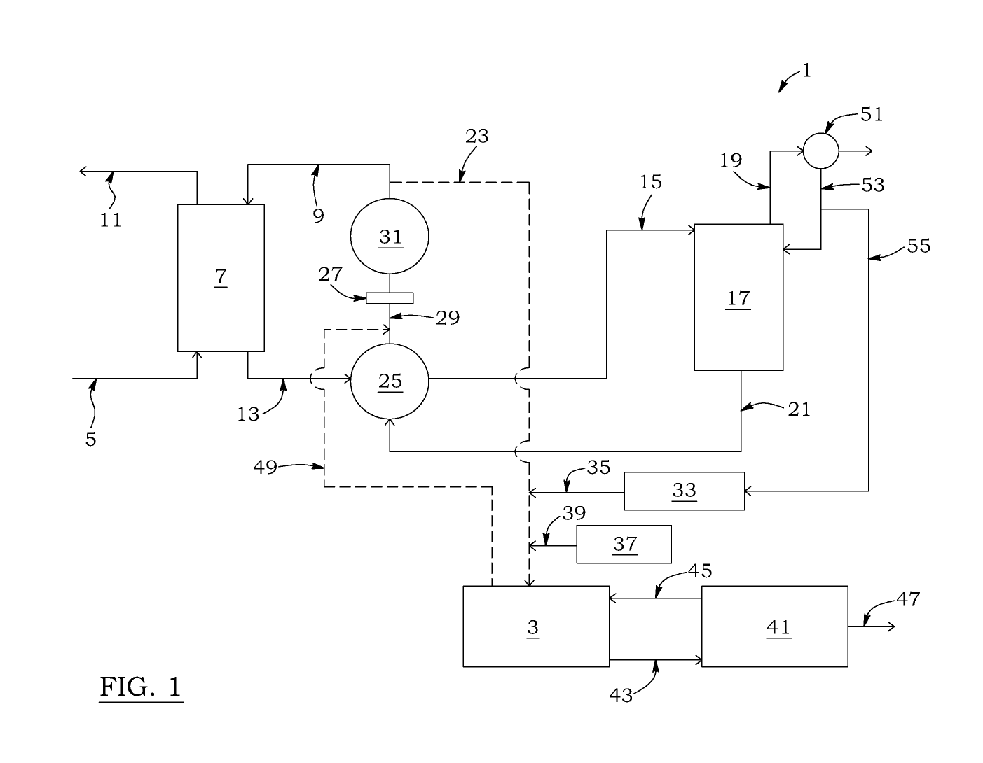

FIG. 1 is a flow diagram illustrating a process according to an embodiment of the invention, in which an electrodialysis cell is utilized in the context of a gas treating process.

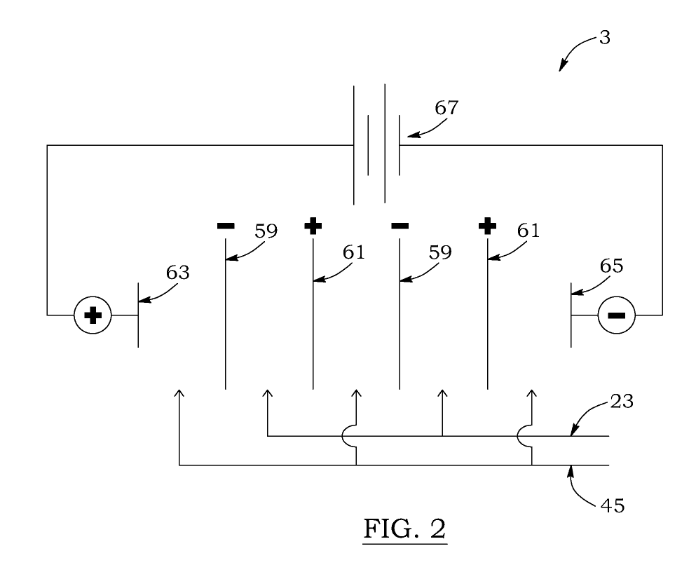

FIG. 2 is a schematic view illustrating the stack and membrane configuration of the electrodialysis cell used according to the first embodiment of the invention.

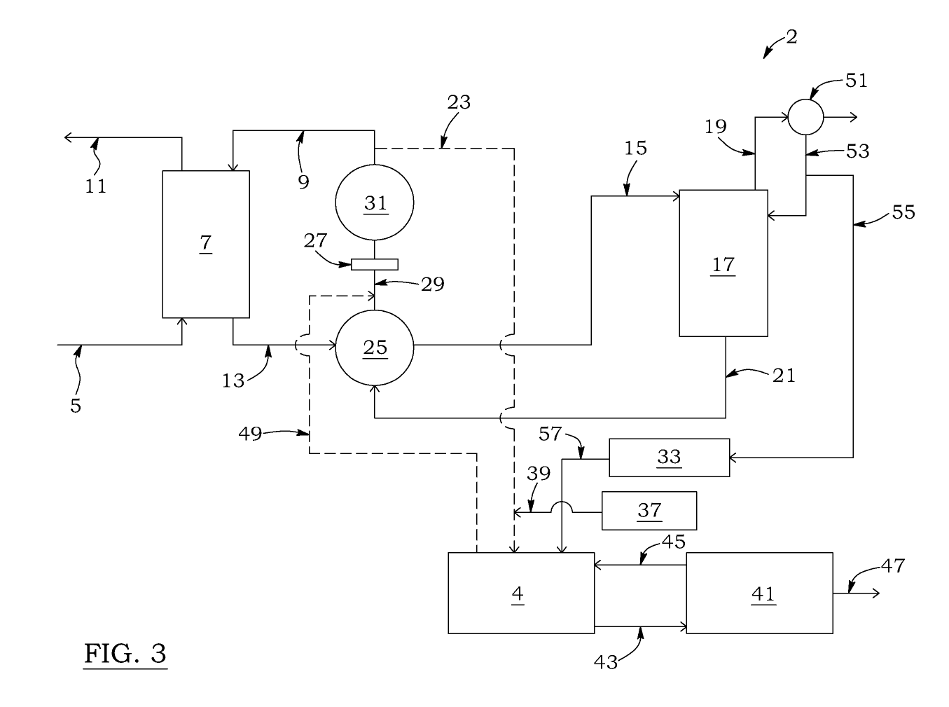

FIG. 3 is a flow diagram illustrating a process according to another embodiment of the invention, in which an electrodialysis cell is utilized in the context of a gas treating process.

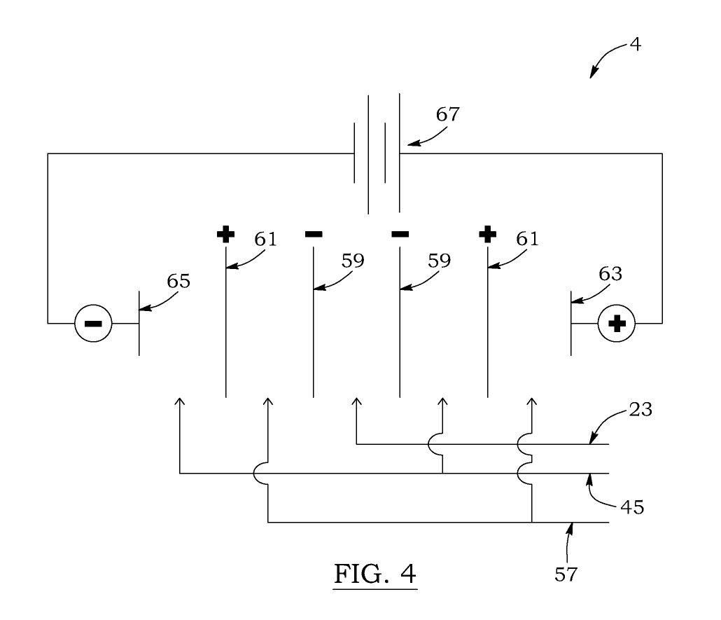

FIG. 4 is a schematic view illustrating the stack and membrane configuration of the electrodialysis cell used according to the second embodiment of the invention.

Feed streams suitable for use in accordance with the present invention generally include any liquid stream comprising a mixture containing at least PGDE and water. The concentration of PGDE is typically over about 90%, but the concentration of PGDE could be higher or lower.

By “about”, it has to be understood that the measures indicated in the present application have a precision which cannot be inferior to the precision of the apparatus used to get this measure. It is commonly accepted that a 10% precision measure is acceptable and encompasses the term “about”.

The absorbent may be composed of polyethylene glycol dimethyl ether (CAS #24991-55-7). Other terms are known such as “tetraglyme”, “dimethyl ether tetraethylene glycol” (CAS#143-24-8), Selexol® RD2 or AGR. The concentration of water is typically from about 5% to 20%. The concentration of heat stable anions may be under about 100 ppm but also up to about 50,000 ppm. It is not uncommon for the feed streams to comprise small amounts, e.g., less than about 2 weight percent (w. %), of other ingredients such as, for examples, antifoams or antioxidants.

The source of the feed stream is typically from the solvent circulation loop of an acid gas absorption process. The feed stream may comprise a slip stream of a lean solvent stream, i.e. regenerated solvent, from the steam stripping column, of an acid gas absorption process. However it is to be understood that the source of the feed stream is not a critical aspect of the present invention.

In addition, the particular acid gas being absorbed in the acid gas absorption process is not a critical aspect of the present invention. Typical acid gases include hydrogen sulphide and carbon dioxide. When hydrogen sulphide is present in the process gas stream, its concentration typically ranges from about 10 to 50,000 parts per million volume (“ppmv”) or even up to 30 volume percent or more. When carbon dioxide is present in the process gas stream, its concentration typically ranges from about 2 to 30 volume percent, although levels of carbon dioxide as high as about 90 volume percent or more are not uncommon. The process gas streams may typically comprise other ingredients such as, for example nitrogen, water, oxygen, light hydrocarbons and sulfur derivatives of light hydrocarbons, e.g., mercaptans.

Heat stable anions and salts may often form during absorption or regeneration in acid gas absorption processes. As used herein, the term “heat stable anions and salts” means any anion or salt, which is not regenerated under the regeneration conditions of the process. For example, typical conditions for regenerating the PGDE (Selexol) absorbent used in an acid gas absorption processes include steam stripping in a distillation column at a temperature of from about 75° C. to 250° C., and at a pressure of about 0.2 to 3 atmospheres. Heat stable anions and salts are also known to those skilled in the art as those salts whose anions correspond to non-volatile or strong acids relative to the strength of the acid gases being regenerably absorbed. Those skilled in the art can determine which anions can form heat stable anions and salts. Typical ions which form heat stable salts, i.e. heat stable anions, include for example, sulfate anions, nitrate anions, thiosulfate anions, thiocyanate anions, halide anions, nitrite anions, polythionate anions, acetate anions, formate anions, oxylate anions and mixtures thereof. Sulphite anions, which are heat regenerable anions, can be heat stable, for example, when present in a hydrogen sulphide or carbon dioxide absorption process.

The feed solution, if above about 90% strength PGDE, may be diluted if the additional water can be subsequently removed in the absorption-desorption process.

Indeed, pure or concentrated PGDE absorbent (Selexol®) is a poor electrical conductivity. Also in order to completely ionize the anions and cations in solution sufficient water must be present. In a typical Selexol® system, the Selexol® concentration is in excess of about 90%. Thus, it is preferable to dilute the Selexol® to less than 90% strength and ideally to less than 80% strength in order to ensure that anions and cations are in their ionic state and to ensure that the solution has sufficient conductivity for the transmission of current in the electrodialysis cell.

Table 1 shows the conductivity of Selexol® at different dilutions concentration:

TABLE 1

| SELEXOL ^{®} (ml) | H₂O (ml) | Conductivity (μS) |
|---|---|---|
| 100 | 0 | 0.56 |
| 50 | 10 | 2.20 |
| 50 | 10 | 200* |
| 50 | 20 | 2.50 |
| 50 | 30 | 5.10 |
| 50 | 40 | 6.83 |
| 50 | 50 | 9.77 |
| 50 | 60 | 11.0 |
| 50 | 70 | 13.58 |

*20,000 ppm ammonia

In one embodiment of the invention, in addition to dilution it is desired to ensure that all anions are neutralized with a cation and preferably with an excess quantity of cation in order to ensure that all anions both heat stable and non-heat stable (such as dissolved CO₂ and H₂S) are also neutralized. The process therefore also uses a sufficient amount of a base to partly or fully neutralize the contained heat stable anions. The base may be added to the feed stream of the electrodialysis continuously in order to ensure that all of the heat stable anions are preferably fully neutralized. Preferably, a slight excess of a base or mixture of bases is added.

Typical bases which can be utilized to convert the anion to a salt include sodium hydroxide, potassium hydroxide or ammonium hydroxide or the equivalent bicarbonate or carbonate. Any inorganic or organic base can be used. Suitable inorganic bases include alkali metal oxides, alkali metal hydroxides and alkaline earth metal carbonates and bicarbonates. A strong base is preferably used. Mixtures of bases can also be used.

If sodium or potassium base is used, the cation can only be removed in the electrodialysis cell.

According to one embodiment of the invention, an ammonia base such as ammonia hydroxide (NH₃OH) is used. As ammonia (NH₃) is volatile, the excess of the base can be easily removed from the stream, for example in the circulating solution overhead of the stripping column by bleeding a quantity of reflux. Bleeding of the reflux will also serve to balance water additions in the electrodialysis cell. Additional control on the water content of the circulating Selexol can also be accomplished by adjusting the lean PGDE (Selexol®) feed temperature to the absorption column.

FIG. 1 illustrates a process flow diagram (1) in which an electrodialysis unit (3) is utilized in the context of a gas treating process to remove heat stable anions and salts.

A feed gas stream (line 5), comprising for instance carbon dioxide, formic acid with the balance comprising water vapor, methane, ethane and nitrogen, is introduced into an absorption zone (7), where the feed gas stream is contacted with a lean solvent stream via line 9, the source of which comprising PGDE, with the balance being mostly water. Absorption in zone (7) may be maintained at temperature of about 20° C. to about 60° C. and a pressure of about 1 atmosphere to about 150 atmospheres and may comprise a packed tower or spray scrubber, the details of which are known to those skilled in the art. Other types of absorption apparatus could be utilized, as it is not critical to the present invention. During absorption of the carbon dioxide, heat stable anions and salt, i.e. having formate anions associated therewith, may be formed.

A product gas stream (line 11) at least partially depleted of carbon dioxide relative to the feed gas stream (line 5) is discharged from absorption zone (7).

A rich solvent stream (lines 13 and 15) comprising absorbed carbon dioxide and the PGDE is discharged from the absorption zone (7), and passed to a regeneration zone (17). Regeneration zone (17) may be a distillation column operated under steam stripping conditions at a temperature of about 75° C. to about 250° C. and a pressure of about 1 atmosphere to about 2 atmospheres, the details of which are known to those skilled in the art. The particular method and apparatus for regeneration is not critical to the present invention.

A regeneration overhead stream (line 19) comprising carbon dioxide and water is discharged from regeneration zone (17). Regenerated lean solvent is discharged from the regeneration zone (17) via line 21.

A slipstream (line 23) is taken from the lean solvent stream (line 9) and introduced into the electrodialysis cell (3), after having eventually the regenerated lean solvent (line 21) passed through a heat exchanger (25), a filter (27) via line 29, and a cooler (31). The configuration of the filter, heat exchanger and cooler can vary depending on the site-specific requirements and are not critical to the invention.

A base solution (33) is added to the lean solvent slip stream (23) via line 35. The addition of the base can be also done in a tank.

Water or other diluting fluids (37) is added to the lean solvent slip stream (23) via line 39.

Salt solution (41) may be recirculated into the electrodialysis zone (3) via lines 43 and 45. Waste products may be withdrawn from the salt circulation loop (41) via line 47. Recirculation of lean solvent, base and salt solution is not critical for this invention. In the design and operation of the electrodialysis stack one may choose to utilize recirculation or a once through approach.

After the electrodialysis cell (3), a lean solvent of absorbent is returned to the process via line 49, the absorbent being at least partially depleted of acidic contaminants, heat stable anions and/or salts thereof.

As illustrated on FIG. 1, a base (33) or a mixture of bases is added directly to the slip stream (23) via line 35, to form the feed stream added to the electrodialysis unit (3). The amount of base to be added may be estimated by measuring a pH of the stream after the addition of the base, on the stream directly or inside the electrodialysis cell. In a loop process, measuring the pH may be done automatically performed as know in the art.

Preferably, the base is hydroxyl ammoniac or ammonium hydroxide (NH₃OH), forming NH₃ in solution which is highly volatile. The regeneration overhead stream (line 19) of the regeneration zone (17) may then comprise a condenser (51) allowing condensing NH₃ into a stream (line 53) that is reinjected in the regeneration zone (17). A part of the stream rich in NH₃ is withdrawn from line 53 as a reflux bleed (line 55) and in one embodiment at least a portion is injected in the lean stream (line 23) conjointly to the base (37). Stream (line 55) will contain both water and ammonium hydroxide and will serve not only as a source of base but also for dilution. Additional dilution and base can be added to the feed stream to the electrodialysis unit via lines 35 and 39.

Electrodialysis is a membrane process, which is used to separate and concentrate ionic species from solutions. This is accomplished by applying a current across a membrane stack containing anionic and cationic membranes. The cationic and anionic membranes are, respectively, permeable to positive and negative ions. The cationic exchange members and the anionic exchange members are alternatively arranged between electrodes. The electrodialysis cell can be of the filter press type of unit-cell type. Any suitable or conventional cationic ion exchange membranes and anionic exchange membranes can be used in the electrodialysis cell.

The electrodialysis unit or cell (3) illustrated on FIG. 2 has a stack and membrane configuration. PGDE (23) is circulated between anionic (59) and cationic (61) membranes of which there can be a number of repeating pairs. The concentrate stream (45) is circulated between an adjacent alternating pair of anionic and cationic membranes. The membrane pairs are bounded by a cathode (65) and anode (63). Power is for instance supplied by a DC power source (67).

The PGDE solution stream (23) is circulated between an anionic membrane (59) and a cationic membrane (61), a cationic membrane always being on the cathode side of the compartment. A salt concentrate stream (45) is circulated between a cationic (61) and an anionic (59) membrane, the cationic membrane being on the anode side of the compartment. Anions are transported across the anionic membrane (61) from the PGDE stream to the salt concentrate stream in the presence of the electric field. Cations are transported across the cationic (61) membrane from the PGDE stream to the salt concentrate stream in the presence of the electric field. Once in the salt concentrate steam, the anions and cations are prevented from leaving the stream by the presence of the cationic and anionic membranes. Commercial electrodialysis units typically contain from about 10 to about 400 repeating pairs of membranes.

FIG. 3 illustrates a process flow diagram (2) according to another embodiment of the invention, in which an electrodialysis unit (4) is utilized in the context of a gas treating process to remove heat stable anions and salts. This configuration is almost identical to the one illustrated on FIG. 1 as detailed herein above, with the exception that the base (33) is fed directly into the electrodialysis cell (4) via line 57.

In this configuration, the electrodialysis cell (4) is also different that the one used in the first configuration (3, FIGS. 1 and 2).

FIG. 4 illustrates the electrodialysis cell (4) used in the process according to the other embodiment mentioned above. Power may be supplied by a DC (67) power source and an anode (63) and cathode (65) bounding the repeating membrane sets (3 membranes).

The electrodialysis unit or cell (4) illustrated on FIG. 4 has a stack and membrane configuration. PGDE (23) is circulated between two anionic (59) membranes of which there can be a number of repeating sets of three. The salt-concentrate stream (45) is circulated between an adjacent pair of anionic (59) and cationic (61) membranes, the cationic membrane being on the anode side of the compartment. An anionic membrane separates the salt concentrate stream and the PGDE stream. The base stream (57) is circulated between an adjacent pair of anionic (59) and cationic (61) membranes. The cationic (61) membrane is on the cathode side of the compartment. An anionic (59) membrane separates the base stream (57) from the PGDE stream (23). A cationic (61) membrane separates the base stream (57) and the salt concentrate stream (45). Anions are transported across the anionic membrane (59) from the PGDE stream to the salt concentrate stream by the presence of the electric field. Anions, typically hydroxide are transported across the anionic membrane from the base (57) stream to the PGDE (23) stream in the presence of the electric field. Cations are transported from the base (57) stream to the waste (45) concentrate stream across a cationic membrane (61) in the presence of an electric field. Once in the salt concentrate steam the anions and cations are prevented from leaving the stream by the presence of the cationic and anionic membranes. Commercial electrodialysis units typically contain from about 10 up to about 400 repeating sets of three membranes.

The feed, waste and base streams can be introduced to the electrodialysis cell (4) on a once through basis or on a recycle basis. When the electrodialysis zone (4) is operated on a recycle basis, a portion of the feed effluent stream and the base effluent stream is recycled back to the feed compartment and the base compartment, respectively. Methods of recycling such streams are generally known to those skilled in the art. Typically, however, holding tanks are employed whereby the feed stream and base stream are introduced to their respective holding tanks. By operating in this fashion, it is possible to maintain essentially any desired flow rates within the compartments in the electrodialysis zone even though the actual flow rates of the feed stream and base stream to the holding tanks may be substantially lower. Effluent streams are then withdrawn from the holding tanks at flow rates, which are essentially equivalent to the flow rates of the feed stream in order to maintain steady state concentrations and volumes.

### EXAMPLE 1

The electrodialysis removal of formate from a mixture of Selexol® and water is tested using a laboratory electrodialysis cell. The cell contains ten (10) compartments or repeat units as shown in FIG. 2. The Selexol® mixture is diluted with water to 80% strength Selexol®. Into 4 litres (L) of the diluted Selexol® mixture, 4 grams (g) of formic acid are added and 3.1 g of ammonium hydroxide are also added in order to neutralize the formic acid to ammonium formate. The start-up waste stream consists of 4 L of water to which 3 g of ammonium hydroxide has been added.

The solution is treated in the electrodialysis test cell. Water is circulated into the waste cells. The ammonium hydroxide ensures that the waste stream has sufficient conductivity to conduct current. Initial solution conductivity is 250 μS (S is for Siemens unit). Initial waste conductivity is 300 μS. Initial formate concentration in the feed stream is 1,000 ppm. Both solutions are circulated though the electrodialysis cell. Initial cell operating voltage and current is 0.7 Ampere (A) at 30 Volts (V). The batch test is run for 3 hours. The operating current increases over time up to about 0.9 A, at a constant of about 30V. Subsequent analysis of the feed indicates that the formate concentration in the feed solution has decreased from about 1,000 ppm to about 350 ppm.

### EXAMPLE 2

In a commercial Selexol® type system, Selexol® circulation rates between the absorption and regeneration columns could be as high as many thousands litres per minutes. From this circulating solution, a bleed stream of about 5 to about 200 litres per minutes is taken and fed to the electrodialysis unit.

A bleed stream of 8 litres per minute is fed to the electrodialysis unit, and contains about 1,000 ppm of formate, 100 ppm of ammonia and 100 ppm of CO₂. This stream has about 0.19 moles per minute of anions (both heat stable and non-heat stable), and 0.05 moles per minutes of cations. To this feed stream, 2 litres of dilution water are added to generate a solution having approximately 80% of Selexol®. The source of water could be reflux bleed from the regeneration column or independent water feed. About 14 ml per minute of 20% ammonium hydroxide is added to the stream in order to fully neutralise the anions with about a 10% excess of cations. The order in which the neutralisation and dilution steps occur is not critical to the process. In the case where reflux is utilised for dilution, the contained ammonia would be subtracted from further ammonium hydroxide additions.

The neutralised and diluted mixture is fed to the electrodialysis system. The solution is circulated in the electrodialysis zone. DC power is applied to the cells. In a typical electrodialysis configuration 60% of the formate, CO₂ with the stoichiometric quantity of ammonia will be transferred to the waste salt stream, which will be bled from the system. The removal efficiency in the electrodialysis cell is a function of the operating conditions of the unit, and is not critical in this example. The depleted Selexol® stream is returned to the main gas treating process. The dilution water and excess ammonia are bled from the system by taking a bleed from the reflux stream in the regeneration tower in order to avoid both water and ammonia accumulating in the process over time. If the reflux cannot be bled from the stream, then ammonia addition to the feed of the electrodialysis feed stream would be reduced in order to control overall ammonia concentration in the circulating Selexol® over time. In this case a sub-stoichiometric quantity may have to be added to the Selexol feed to the electrodialysis unit. This would reduce the efficiency of the electrodialysis system.

If water cannot be bleed from the reflux stream, it can be evaporated in the absorption column by adjusting the Selexol® feed temperature.

### EXAMPLE 3

8 litres per minute of Selexol® are fed to the electrodialysis unit. The Selexol® feed is diluted with 2 litres per minute of water. Reflux could be utilised for dilution. The diluted Selexol® fed is introduced into the electrodialysis unit and is then circulated through the electrodialysis zone as depicted in FIG. 4 having an appropriate number of repeating sets of membranes. Power is applied to the membrane stack. Base is circulated in the stack. 14 ml per minute of 20% ammonia make-up is fed to the recirculating base stream and injected to the electrodialysis unit. Reflux could be utilised for all or part of the ammonia make-up. Ammonia cations in the base stream migrate directly into the salt concentrate stream through the membranes. As with example 2, approximately 60% of the anions are removed from the Selexol® stream. The depleted stream is returned to the circulating solution in the gas treating process. The excess water is removed from the Selexol® as in example 2. If reflux is utilised for dilution, sufficient reflux will have to be bled from the regeneration column in order to control the ammonia content in the circulating Selexol®.

The scope of the claims should not be limited by the preferred embodiments set forth in the examples, but should be given the broadest interpretation consistent with the description as a whole.

1. A process for removing contaminants containing acids and salts thereof from an absorbent comprising polyethylene glycol dimethyl ethers, hereinafter named PGDE, the process comprising the steps of:
contacting the absorbent with a base for partly or fully converting the contaminants into their corresponding salts containing anions and cations;
adding a fluid to the absorbent for diluting the PGDE;
introducing the absorbent into an electrodialysis cell;
electrodialyzing the absorbent for removing the salts from the absorbent; and
recovering the absorbent depleted of acidic contaminants;
the absorbent being contacted with the base before being introduced into the electrodialysis cell, or directly inside the electrodialysis cell.

2. The process of claim 1, wherein the absorbent is contacted with the base before being introduced into the electrodialysis cell, the electrodialysis cell comprising:
a cathode and an anode operatively connected to an electric power supply, and at least one repeat unit located between the anode and the cathode, each repeat unit comprising two ion exchange membranes delimiting a feed compartment between the two ion exchange membranes and a waste compartment adjacent to the feed compartment;
the process further comprising the steps of:
introducing the absorbent comprising the base into the feed compartment of the electrodialysis cell;
applying a current potential transversely across the compartments of the electrodialysis cell, said current potential being effective to cause at least a part of the anions and cations present in the feed compartment to exit the feed compartment through the membranes; and
discharging the absorbent from the feed compartment, the absorbent being depleted of anions and cations.

3. The process of claim 1, wherein the absorbent is contacted with the base inside the electrodialysis cell, the electrodialysis cell comprising:
a cathode and an anode operatively connected to an electric power supply, and at least one repeat unit located between the cathode and the anode, each unit comprising three ion exchange membranes delimiting a feed compartment; a base-source compartment between the feed compartment and the cathode compartment, and a waste compartment between the feed compartment and the anode compartment;
the process further comprising the steps of:
introducing the absorbent into the feed compartment;
introducing the base into the base-source compartment;
passing a current potential transversely across the compartments, said current being effective to dissociate the base in the base compartment into corresponding anions and cations, the anions of the base then passing into the feed compartment for contacting the absorbent and the cations of the base then passing into the waste compartment; and
discharging the absorbent from the feed compartment, the absorbent being depleted of anions and cations.

4. The process of claim 2, further comprising the steps of:
discharging a feed stream from the feed compartment and recycling at least a portion of the feed stream to the feed compartment; and/or
discharging a waste stream from the waste compartment and recycling a least a portion of the waste stream to the waste compartment.

5. The process of claim 2 to wherein the electrodialysis cell comprises from about 10 to about 400 repeat units ion exchange membranes.

6. The process of claim 1, wherein the base comprises sodium hydroxide, potassium hydroxide, ammonium hydroxide, carbonate or bicarbonate thereof, or mixture thereof.

7. The process of claim 1, wherein the base is ammonium hydroxide.

8. The process of claim 1, in which the absorbent is diluted by addition of water and/or a reflux to the absorbent before being fed to the electrolysis zone.

9. The process of claim 8, wherein the reflux is a basic reflux allowing partial neutralization of the acidic contaminants of the absorbent.

10. A loop process for recovering acid gas from an acid gas stream, the loop process comprising the steps of:
i) passing an acid gas stream to an absorption zone wherein the acid gas stream is contacted with an absorbent of acid gases comprising polyethylene glycol dimethyl ethers PGDE;
ii) withdrawing from the absorption zone a product gas stream depleted of acid gases relatively to the gas stream;
iii) withdrawing from the absorption zone a rich solvent stream comprising the absorbent and absorbed contaminants having acids and salt thereof;
iv) passing the rich solvent stream to a regeneration zone wherein absorbed acid gases are desorbed from the rich solvent stream to provide a first tail gas stream comprising acid gases, and a lean solvent stream is formed, said lean solvent stream comprising PGDE absorbent and remaining contaminants having acids and salt thereof;
v) passing the lean solvent stream withdrawn from the regeneration zone to the absorption zone of step (i) for further treatment in the loop process;
vi) partially withdrawing via a bleed stream an amount of the lean solvent stream before the absorption zone;
vii) injecting a fluid to the bleed stream for diluting the PGDE;
viii) contacting the absorbent of the bleed stream with a base for partly or fully converting the contaminants into their corresponding salts containing anions and cations;
ix) introducing the absorbent into an electrodialysis cell;
x) electrodialyzing the absorbent for removing the salts from the absorbent; and
xi) recovering the absorbent depleted of acidic contaminants or slats thereof;
the absorbent being contacted with the base before being introduced into the electrodialysis cell, or directly inside the electrodialysis cell.

11. The loop process of claim 10, wherein the absorbent is contacted with the base before being introduced into the electrodialysis cell, the electrodialysis cell comprising:
a cathode and an anode operatively connected to an electric power supply, and at least one repeat unit located between the anode and the cathode, each repeat unit comprising two ion exchange membranes delimiting a feed compartment between the two ion exchange membranes and a waste compartment adjacent to the feed compartment;
the loop process further comprising the steps of:
introducing the absorbent previously contacted with the base into the feed compartment of the electrodialysis cell;
applying a current potential transversely across the compartments of the electrodialysis cell, said current potential being effective to cause at least a part of the anions and cations present in the feed compartment to exit the feed compartment through the membranes; and
discharging the absorbent from the feed compartment, the absorbent being depleted of anions and cations.

12. The loop process of claim 10, wherein the absorbent is contacted with the base inside the electrodialysis cell, the electrodialysis cell comprising:
a cathode and an anode operatively connected to an electric power supply, and at least one repeat unit located between the cathode and the anode, each unit comprising three ion exchange membranes delimiting a feed compartment; a base-source compartment between the feed compartment and the cathode compartment, and a waste compartment between the feed compartment and the anode compartment;
the loop process further comprising the steps of:
introducing the absorbent into the feed compartment;
introducing the base into the base-source compartment;
passing a current potential transversely across the compartments, said current being effective to dissociate the base in the base compartment into corresponding anions and cations, the anions of the base then passing into the feed compartment for contacting the absorbent and the cations of the base then passing into the waste compartment; and
discharging the absorbent from the feed compartment, the absorbent being depleted of anions and cations.

13. The loop process of claim 11, further comprising the steps of:
discharging a feed stream from the feed compartment and recycling at least a portion of the feed stream to the feed compartment, and/or
discharging a waste stream from the waste compartment and recycling a least a portion of the waste stream to the waste compartment.

14. The loop process of claim 11, wherein the electrodialysis cell comprises from about 10 to about 400 repeat units ion exchange membranes.

15. The loop process of claim 10, wherein the base comprises sodium hydroxide, potassium hydroxide, ammonium hydroxide, carbonate or bicarbonate thereof, or mixture thereof.

16. The loop process of claim 10, wherein the base is ammonium hydroxide.

17. The loop process of claim 10, in which the absorbent is diluted by addition of water and/or a reflux to the absorbent.

18. The loop process of claim 17, wherein the base is ammonium hydroxide and the reflux is obtained from the ammonium hydroxide presents in the loop that evaporates from the regeneration zone with the tail gas stream, the tail gas stream being partly condensed to form a stream containing ammonium hydroxide which is reinjected in the regeneration zone, a portion of the stream containing ammonium hydroxide being withdrawn before the regeneration zone to be injected to the lean stream containing the absorbent as the reflux.
